(19) United States
(12) Patent Application Publication
(10) Pub. No.: US 2005/0229312 A1
(43) Pub. Date: Oct. 20, 2005

(54) Loading support structure for patient transport cart

(75) Inventor: Joseph Bishop, Phoenixville, PA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Tactical Medical Equipment Corp.

(21) Appl. No.: 10/824,148

(22) Filed: Apr. 14, 2004

(51) Int. Cl. A61G 13/06; A61G 7/018

(52) U.S. Cl. 5/620; 5/611

(57) ABSTRACT

A support structure for supporting a rear portion of a patient transport cart is described. The support structure supports the weight at the rear of the cart during normal operation and while loading and unloading of the cart into and out of an ambulance, i.e., at times when the undercarriage of the cart is folded into a compact position and the ambulance is supporting only the front end of the cart. The support structure includes a main body assembly, a wheel assembly attached to the bottom of the main body assembly and oriented to rotate about a horizontal axis while supporting the main body assembly, and an attaching means attaching the main body assembly to a member of the patient transport cart proximate to the rear portion of the patient transport cart.

### BACKGROUND

The present invention relates to devices for transporting patients. More particularly, the present invention relates to a detachable rear support structure for a patient transport cart.

Patient transport carts, also called carts, are typically used for providing transport for a patient from a point of injury, e.g., an accident scene, to an ambulance and again from the ambulance to a hospital bed. One or more Emergency Medical Technicians (EMTs) are responsible for safely transporting the patient. The EMTs often encounter risks of personal injury while performing these duties. One such risk is the risk of back injuries routinely faced with the required repetitive lifting of average size patients or occasional lifting of large patients.

Prior art carts will typically support the weight of the patient during transport to and from the ambulance but require some lifting and/or supporting of patient weight by the EMT(s) when inserting and removing the cart from the ambulance. They typically include collapsible frame so the cart can be more compact in the ambulance, leaving more room for the EMT(s) to care for the patient in route. Some prior art carts must be collapsed and lifted wholly into the ambulance, while others are designed to be pushed directly into the back of the ambulance.

For example, U.S. Pat. No. 3,759,565 describes a cart with an x-frame support. The cart includes a bed and auxiliary wheels at the forward portion of the underside of a bed. An EMT can thrust the cart forward into the vehicle bed between the open rear doors of an ambulance. The auxiliary wheels engage the vehicle bed and serve to support the forward end of the cart as the x-frame support folds upward to the underside of the cart bed.

U.S. Pat. No. 5,022,105 describes a similar cart having an x-frame support with auxiliary wheels at the forward portion but includes a pneumatic system that automatically folds the x-frame support under the control of the EMT operator. The auxiliary wheels engage the vehicle bed and serve to support the forward end of the cart and the EMT activates a switch to fold the x-frame support upward while the EMT supports the rear of the cart.

The problem with the prior art approach, however, is that the EMT(s) must support the weight at the back of the cart while the front is supported by the ambulance bed until the cart is inserted into the ambulance. Accordingly, EMTs are still routinely subject to an increased risk of back injuries. This consequence results in a significant number of disabling back injuries to EMT personnel each year. In addition, because of the strength that is required to support the cart, otherwise qualified personnel are effectively precluded from working as an EMT due to physical strength limitations.

A need therefore exists for a support structure to support the rear of the cart while the cart is being guided into and/or is being withdrawn from the ambulance bed and while the rear portion of the cart is not supported by the ambulance bed.

### SUMMARY

Accordingly, a support structure for supporting a rear portion of a patient transport cart is disclosed. The support structure supports the weight at the rear of the cart during normal operation and while loading and unloading of the cart into and out of an ambulance, i.e., at times when the undercarriage of the cart is folded into a compact position and the ambulance is supporting only the front end of the cart.

According to exemplary embodiments, the support structure includes a main body assembly, a wheel assembly attached to the bottom of the main body assembly and oriented to rotate about a horizontal axis while supporting the main body assembly, and an attaching means attaching the main body assembly to a member of the patient transport cart proximate to the rear portion of the patient transport cart. The support structure can be removably attached or integrated into the patient transport cart, i.e., more permanently attached.

The main body attaching means includes support members having a mating portion adapted to be inserted into a receiving means attached to the member of the patient transport cart and be removably secured therein by securing means. For example, the securing means of the mating portion can include a spring loaded retractable button.

The main body assembly preferably includes an upper member and a lower member that telescopingly cooperate under control of a height adjustment means.

In an alternative embodiment, the main body attaching means includes a hinged connection between the main body assembly and the member of the patient transport cart. The hinged connection is oriented such that the support structure can be folded forward from the vertical rear proximate position to a horizontal position adjacent to an underside of the patient transport cart.

### BRIEF DESCRIPTION OF THE DRAWINGS

These and other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1A illustrates a conventional patient transport cart according to the prior art;

FIG. 1B illustrates a conventional patient transport cart in a compact position according to the prior art;

FIG. 2A illustrates a patient transport cart with a support structure according to an embodiment of the invention;

FIG. 2B illustrates a patient transport cart in a compact position with a support structure according to an embodiment of the invention;

FIGS. 3A and 3B illustrate a rear and side view of a support structure according to an embodiment of the invention;

FIGS. 4A, 4B, and 4C illustrate alternative embodiments of attaching means according to embodiments of the invention;

FIG. 5 illustrates a side view of a support structure according to another embodiment of the invention; and

FIG. 6 illustrates an alternative wheel assembly according to an embodiment of the invention.

### DETAILED DESCRIPTION OF THE PREFERRED EMBODIMENTS

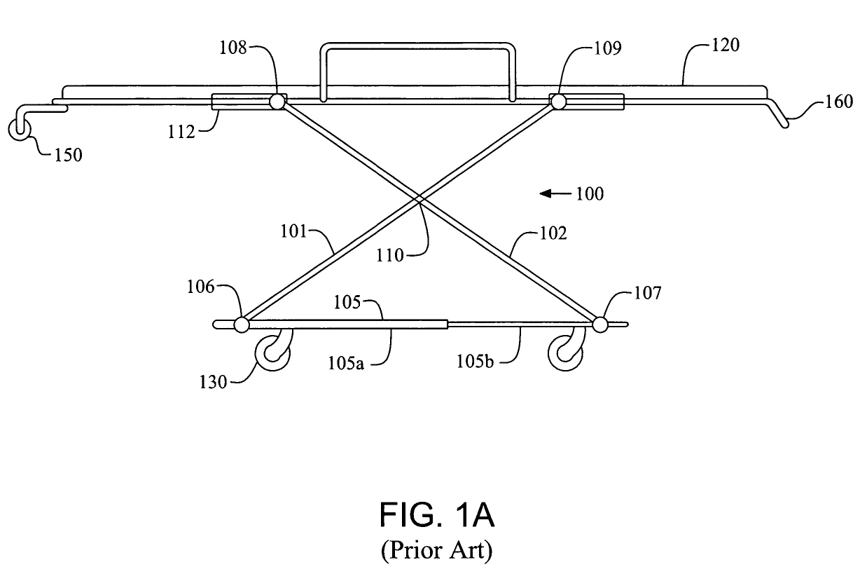

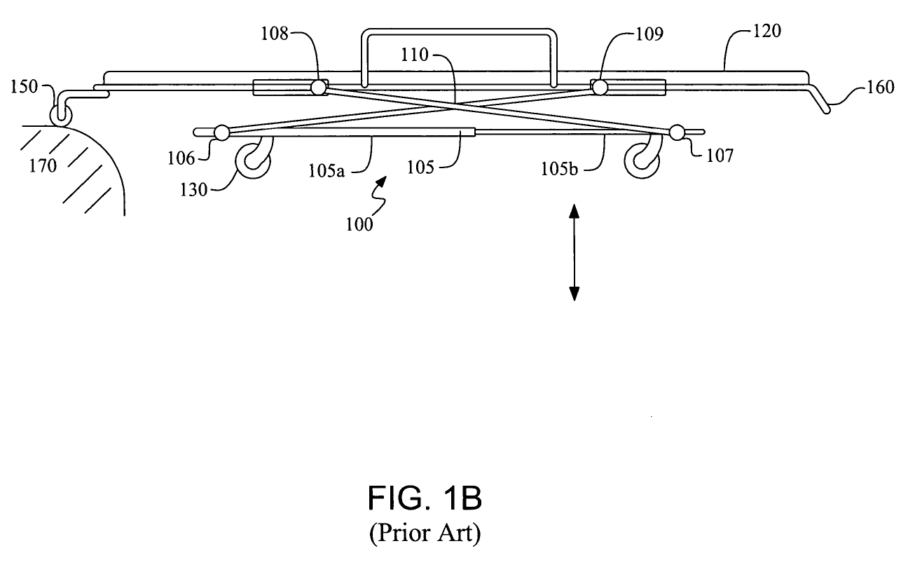

Referring to the drawings, FIGS. 1A and 1B illustrate a conventional patient transport cart according to the prior art. The cart comprises an x-frame structure 100 typically formed of tubular aluminum. The x-frame 100 includes a rectangular undercarriage portion 105 pivotally interconnected at pivot points 106, 107 via two forward legs 101 and two rear legs 102, respectively, cooperating to form two scissor linkage configurations, and joints 108, 109 to a patient supporting portion, or bed 120. One scissor linkage configuration is shown in the figure. A second scissor linkage configuration is operating at the other side of the cart (not shown). The legs 101, 102 of the scissor linkages are hinged together at a central pivot point 110. The rectangular undercarriage portion 105 includes four wheels 130 for engaging the terrain.

The x-frame 100 is adjustable between an extended position in which the bed 120 is remote from the undercarriage portion 105, as shown in FIG. 1A, and a more compact folded position in which the bed 120 is adjacent to the undercarriage portion 105, as shown in FIG. 1B. Joints 108 and 109 are movable forward and backward within corresponding grooves or rails 112 on the underside of the bed 120. Alternatively, only one of joints 108 and 109 are movable forward and backward, and the other is rotatable. The undercarriage portion 105 includes telescopingly cooperating tubular members 105a, 105b that move toward and away from each other as the x-frame 100 is folded. Alternatively, one or more of the x-frame members will have telescopingly cooperating tubular members.

The x-frame 100 may be folded to the compact position either manually or with the aid of a pneumatic or other lift assisting system under the control of the EMT operator. Some prior art carts may include additional linkages (not shown) at the front of the cart that engage the ambulance bed when the cart is inserted into the ambulance and cause the x-frame to fold upward to the compact position. In each case, a pair of bed wheels 150 are provided at the front of the cart to engage the ambulance bed 170 (FIG. 1B) and support only the front portion of the cart in the compact position. The EMT(s) must support the weight at the rear of the cart by applying an upward force at the rear of the cart, for example, while holding a rear handle 160. To remove the cart from the ambulance, the EMT(s) roll the cart out of the ambulance door until only the wheels 150 are left supported by the ambulance bed 170, while applying an upward force at the rear handle 160, and unfold the x-frame to the extended position until the undercarriage portion 105 is lowered to the ground. Thus, when the cart is being loaded into or unloaded out of an ambulance, a significant portion of the weight must be supported by the EMT(s).

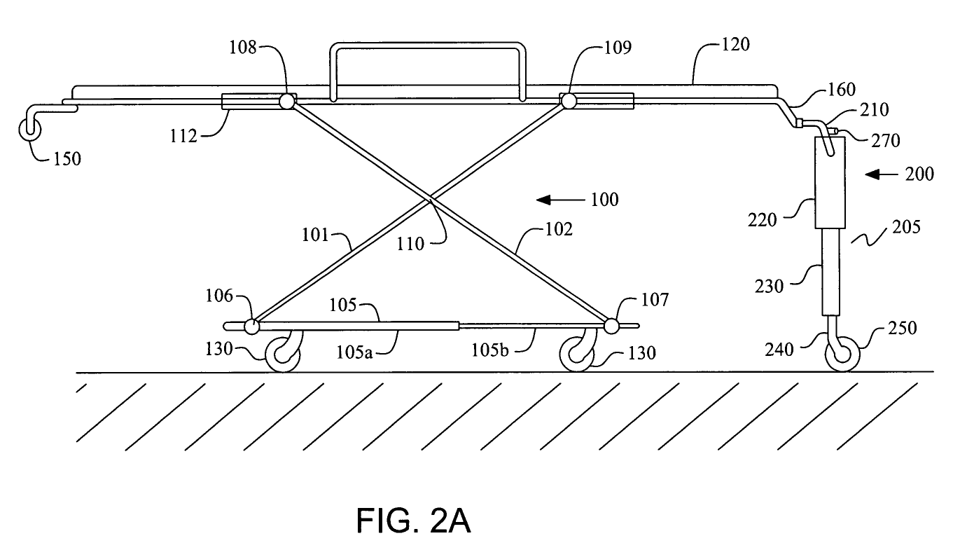

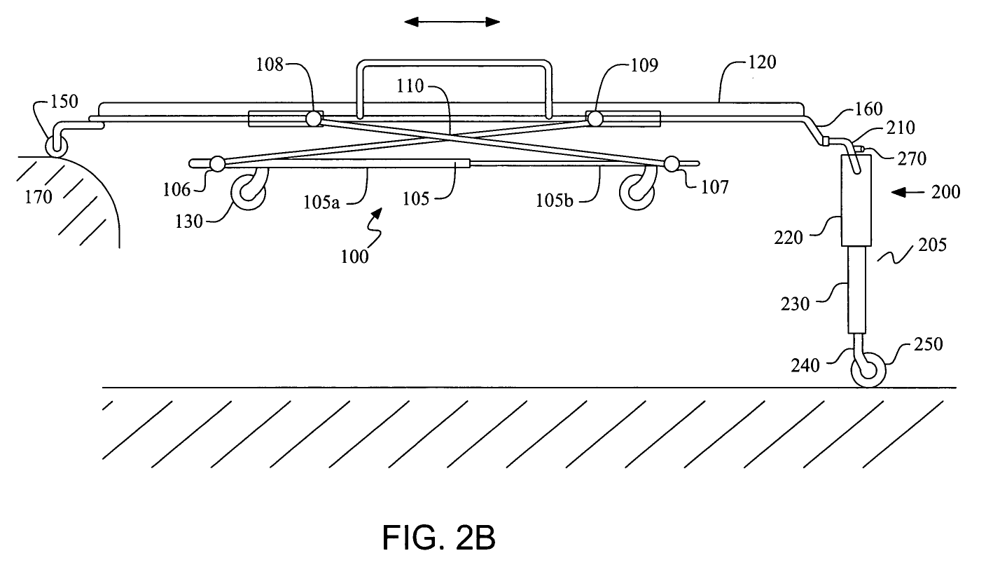

According to the invention, a support structure is attached to the rear of the cart to support the weight at the back of the cart while the cart is in a compact mode and until the cart is inserted into or removed from the ambulance. FIGS. 2A and 2B illustrate a loading support structure according to one embodiment of the invention.

Referring to FIG. 2A, a support structure 200 according to an embodiment of the invention comprises removable attaching means 210, an upper tubular member 220, a lower tubular member 230, a wheel support 240, a wheel assembly 250, and optional height adjustment means 270. The upper and lower tubular members 220, 230 make up a main body assembly 205 and can be rigidly attached or can be upper and lower parts of the same tubular member. The wheel of the support structure is positioned in contact with the terrain and swivels about a vertical axis according to the direction of movement of the cart. The support structure 200 is preferably comprised of a lightweight metal, such as aluminum, except the wheel 250, which may be comprised of metal, rubber, nylon, or other commonly used materials, alone or in combination.

Referring to FIG. 2B, when the bed wheels 150 of the cart engage the ambulance bed 170, the undercarriage 105 is raised into the compact position by the EMT(s) using manual or automatic means. The weight of the cart is still fully supported by the ambulance bed 170 at the front and the support structure 200 at the rear. As the cart is pushed forward by the EMT(s), the support structure 200 continues to support the rear of the cart until the cart is near fully inserted into the ambulance, e.g., when a rear set of the wheels 130 engage the ambulance bed 170, at which time the support structure is removed by the EMT(s) and the cart is pushed to a position fully within the ambulance.

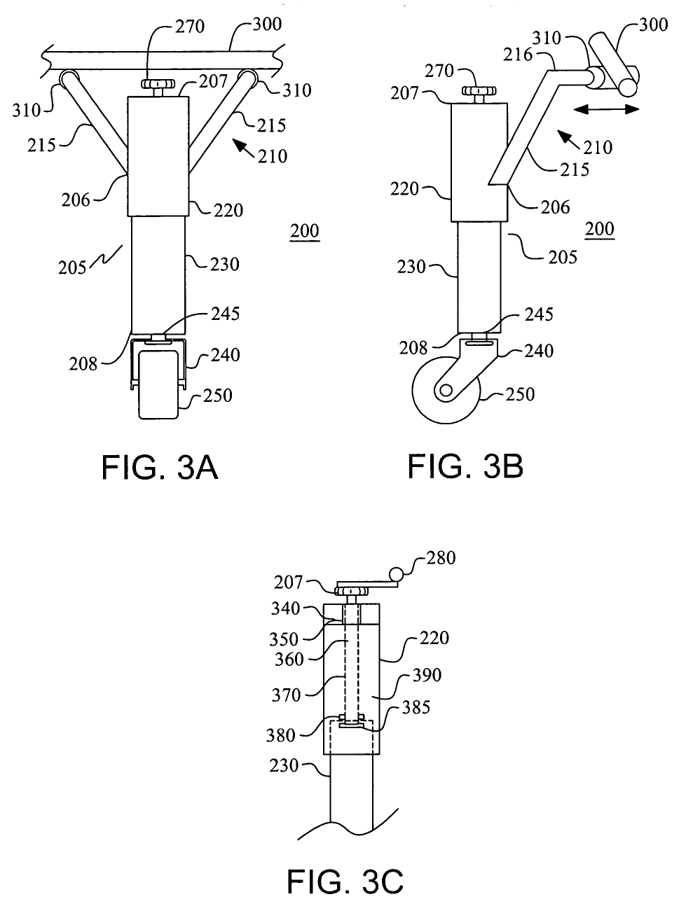

Referring to FIGS. 3A and 3B, a rear and side view, respectively, of a support structure 200 according to an embodiment of the invention is shown. The main body assembly 205 includes an upper section 207, middle section 206, and bottom section 208. Tubular receivers 310 are affixed to a member 300 located at or proximate to the rear of the cart. The member 300 may be, for example, part of a rear handle or frame member of the cart. The attaching means 210 of the support structure includes two diagonal supporting members 215 each attached to opposing sides of the main body assembly 205 at the middle section 206 and each comprising a mating portion 216 adapted to be inserted into the tubular receiving means 310, remain there securely, and to be easily removed from the tubular receiving means 310 by the EMT(s).

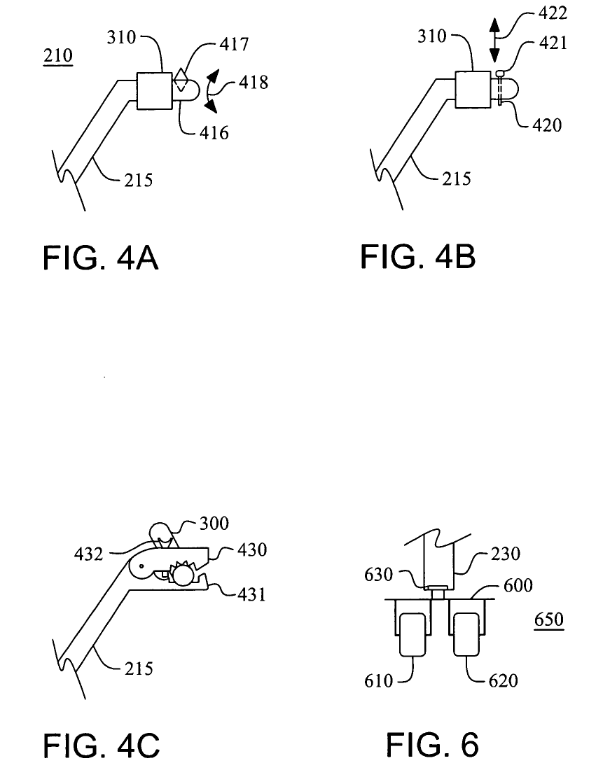

It will be appreciated by those of ordinary skill in the art that many configurations can be employed for the attaching means 210. For example, as illustrated in FIG. 4A, a mating portion 416 can include a spring loaded retractable button 417 that is held externally protruding from the surface of the mating portion 416 by the force of an internal spring and retracts within the mating portion 416 when pressure is applied. The direction of retraction and protrusion is shown by arrow 418. The button 417 is shaped with an incline at the leading edge so the button 417 automatically retracts upon the mating portion 416 being inserted into the tubular receiving means 310 and automatically “pops out” to the protruded position under the force of the internal spring once the button 417 has completely passed through the tubular receiving means 310 to the other side. The protruded button 417 serves to hold the support structure 200 attached to the member 300 of the cart. To remove the support structure 200 from the cart, the button 417 is depressed and the mating portion 416 is withdrawn from the tubular receiving means 310 by a rearward force being applied to the support structure 200, e.g., by an EMT.

Alternatively, as illustrated in FIG. 4B, a pin 421 may be inserted and removed from a hole in the mating portion 420 in the direction shown 422, according to another embodiment of the invention.

In yet another embodiment, the tubular receiving means 310 may be omitted and the support structure 200 may be attached directly to the member 300. For example, as illustrated in FIG. 4C, cooperating upper and lower clamp members 430, 431 can be placed around the member 300 and tightened with a tightening means 432, such as a thumb screw.

In the illustrated embodiments, the support structure 200 is easily removable as described above. Alternatively, the support structure 200 may also be more permanently affixed to the cart using screws or other known affixing means.

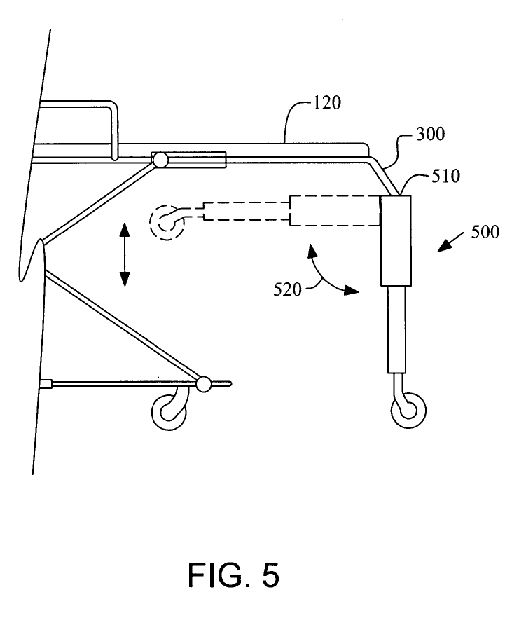

In an alternative embodiment, the support structure 500 may be hinged to allow the support structure 500 to fold forward to a horizontal position adjacent to the under side of the cart bed 120, as illustrated in FIG. 5. In FIG. 5, the support structure 500 is hingedly attached to the member 300 at a hinge point 510. The EMT(s) can fold the support structure forward, in a direction indicated by arrows 520, once the cart is inserted into the ambulance beyond a midpoint of the cart such that there is little or no weight at the back of the cart. Although for illustrative purposes the support structure 500 is shown hinged at hinge point 510, it should be understood that there are many possible variations for the hinge point location and hinge type for hingedly attaching the support structure 500 to the member 300.

Referring to FIGS. 3A-3C, in a preferred embodiment, the support structure 200 includes height adjustment means 270, which allows an EMT operator to vary the length of the support structure 200 to adjust to varying terrain and varying cart heights. The adjustability also allows the EMT operator to “off-weight” the support structure 200, i.e., disengage the wheel from the ground, prior to removal. The upper and lower tubular members 220, 230 cooperate telescopingly under the control of the height adjustment means 270.

With reference to FIG. 3C specifically, the height adjustment means 270 is connected to an internal shaft 360 within the upper tubular member 220. The internal shaft 360 includes outer threads 370 that mate with inner threads 350 within a portion 340 of the interior of the upper tubular member 220. The rest of the interior of the upper tubular member 220 is an open area 390 to provide clearance for the lower tubular member 230 to move up and down. As the height adjustment means 270 is turned, a bottom 380 of the internal shaft 360 moves up and down, depending on the direction turned. The internal shaft 360 connects to the lower tubular member 230 via connecting means 385, for example through a hole at the top of the lower tubular member 230. The connecting means 385 allows the internal shaft 360 to rotate freely while securing the lower tubular member 230 to follow the up and down movement of the internal shaft 360, which varies the length of the support structure 200 and provides the height adjustment. The height adjustment means 270 may optionally include a crank 280 for ease of operation.

As can be appreciated by one of ordinary skill in this art, there are many alternative mechanisms that may be employed to provide height adjustment. For example, a ratcheting mechanism may be employed. Other lift assist mechanisms such as pneumatic systems or hydraulic systems may also be employed.

FIG. 6 illustrates an alternative wheel configuration for the support structure 200. A wheel assembly 650 comprises two wheels 610, 620 that are connected via a common member 600 to a swivel pin 630, which rotatably connects the wheel assembly 650 to the lower tubular member 230 such that the wheel assembly 650 rotates about a vertical axis.

In a preferred embodiment, whether one or two wheels are employed, the wheel(s) include a brake controlled by a lever (not shown) adjacent the wheel that prevents wheel rotation when engaged. The brake is engaged to prevent the cart from rolling away when the cart is left in a stationary position.

It will be appreciated by those of ordinary skill in the art that the invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A support structure for supporting a rear portion of a patient transport cart, comprising:
a main body assembly comprising at least one vertical tubular member and having a top, bottom, and middle section;
a wheel assembly comprising at least one wheel, the wheel assembly attached to the bottom of the main body assembly by a wheel attaching means, wherein the at least one wheel is oriented to rotate about a horizontal axis while supporting the main body assembly; and
an attaching means for attaching the main body assembly to a member of the patient transport cart proximate to the rear portion of the patient transport cart.

2. The support structure of claim 1, wherein the support structure is removably attachable by the main body attaching means.

3. The support structure of claim 2, wherein the main body attaching means comprises at least one support member having first and second ends, the support member being attached to the main body assembly at the first end and having a mating portion at the second end, wherein said mating portion is adapted to be inserted into a receiving means attached to the member of the patient transport cart and be removably secured therein by a securing means of the mating portion.

4. The support structure of claim 3, wherein the main body attaching means comprises two diagonal support members each having the mating portion and being attached to the main body assembly at the middle section.

5. The support structure of claim 3, wherein the securing means of the mating portion includes a spring loaded retractable button.

6. The support structure of claim 3, wherein the securing means of the mating portion includes a removable pin.

7. The support structure of claim 2, wherein the main body attaching means comprises at least one support member having first and second ends, the support member being attached to the main body assembly at the first end and having clamping means at the second end, wherein said clamping means are adapted to clamp on to the member of the patient transport cart and be removably secured thereto.

8. The support structure of claim 1, wherein the main body assembly comprises an upper member and a lower member, said upper and lower members telescopingly cooperating under control of a height adjustment means.

9. The support structure of claim 8, wherein the height adjustment means comprises a knob connected to a threaded shaft adapted to thread through an interior of the upper member and apply force to the lower member, wherein turning the knob threads the threaded shaft through the interior of the upper member and applies the force to the lower member to thereby adjust a height of the support structure.

10. The support structure of claim 9, wherein the height adjustment means further comprises a crank handle attached to the knob.

11. The support structure of claim 8, wherein the height adjustment means comprises a ratcheting type height adjustment.

12. The support structure of claim 1, wherein the wheel assembly comprises two wheels attached to each other via a common member, the common member being attached to the bottom of the main body assembly.

13. The support structure of claim 1, wherein the wheel assembly is rotatably connected to the bottom of the main body assembly through a swivel pin, such that the wheel assembly rotates about a vertical axis.

14. A support structure for supporting a rear portion of a patient transport cart, comprising:
a main body assembly comprising at least one vertical tubular member and having a top, bottom, and middle section;
a wheel assembly comprising at least one wheel, the wheel assembly attached to the bottom of the main body assembly by a wheel attaching means, wherein the at least one wheel is oriented to rotate about a horizontal axis while supporting the main body assembly; and
an attaching means for attaching the main body assembly to a member of the patient transport cart proximate to the rear portion of the patient transport cart;
wherein the main body attaching means comprises a hinged connection between the main body assembly and the member of the patient transport cart, said hinged connection oriented such that the support structure can be folded forward from the vertical rear proximate position to a horizontal position adjacent to an underside of the patient transport cart.

15. A patient transport cart having a support structure for supporting a rear portion of the patient transport cart, the support structure comprising:
a main body assembly comprising at least one vertical tubular member and having a top, bottom, and middle section;
a wheel assembly comprising at least one wheel, the wheel assembly attached to the bottom of the main body assembly by a wheel attaching means, wherein the at least one wheel is oriented to rotate about a horizontal axis while supporting the main body assembly; and
an attaching means for attaching the main body assembly to a member of the patient transport cart proximate to the rear portion of the patient transport cart.

16. The support structure of claim 15, wherein the support structure is removably attachable by the main body attaching means.

17. The support structure of claim 16, wherein the main body attaching means comprises at least one support member having first and second ends, the support member being attached to the main body assembly at the first end and having a mating portion at the second end, wherein said mating portion is adapted to be inserted into a receiving means attached to the member of the patient transport cart and be removably secured therein by a securing means of the mating portion.

18. A patient transport cart having a support structure for supporting a rear portion of the patient transport cart, the support structure comprising:
a main body assembly comprising at least one vertical tubular member and having a top, bottom, and middle section;
a wheel assembly comprising at least one wheel, the wheel assembly attached to the bottom of the main body assembly by a wheel attaching means, wherein the at least one wheel is oriented to rotate about a horizontal axis while supporting the main body assembly; and
an attaching means for attaching the main body assembly to a member of the patient transport cart Proximate to the rear portion of the patient transport cart;
wherein the main body attaching means comprises a hinged connection between the main body assembly and the member of the patient transport cart, said hinged connection oriented such that the support structure can be folded forward from the vertical rear proximate position to a horizontal position adjacent to an underside of the patient transport cart.

19. The support structure of claim 15, wherein the main body assembly comprises an upper member and a lower member, said upper and lower members telescopingly cooperating under control of a height adjustment means.

20. The support structure of claim 19, wherein the height adjustment means comprises a knob connected to a threaded shaft adapted to thread through an interior of the upper member and apply force to the lower member, wherein turning the knob threads the threaded shaft through the interior of the upper member and applies the force to the lower member to thereby adjust a height of the support structure.
